(19) United States
(12) Patent Application Publication
(10) Pub. No.: US 2024/0363981 A1
(43) Pub. Date: Oct. 31, 2024

(54) LITHIUM-ION BATTERY

(71) Applicant: Volkswagen Aktiengesellschaft, Wolfsburg (DE)

(72) Inventor: Marco JORDAN, Salzgitter (DE)

(73) Assignee: Volkswagen Aktiengesellschaft, Wolfsburg (DE)

(21) Appl. No.: 18/646,686

(22) Filed: Apr. 25, 2024

(30) Foreign Application Priority Data
Apr. 26, 2023 (DE) 10 2023 203 849.8

(51) Int. Cl. H01M 50/54; H01M 10/0525; H01M 10/0585; H01M 50/105

(52) U.S. Cl. CPC H01M 50/54; H01M 10/0525; H01M 10/0585; H01M 50/105

(57) ABSTRACT

A lithium-ion battery having at least one storage cell, wherein the storage cell has at least one electrode sheet. The at least one electrode sheet is extended in a longitudinal direction. The at least one electrode sheet has an electrode current collector. The electrode current collector forms two contact tags, namely a first contact tag and a second contact tag.

This nonprovisional application claims priority under 35 U.S.C. § 119(a) to German Patent Application No. 10 2023 203 849.8, which was filed in Germany on Apr. 26, 2023, and which is herein incorporated by reference.

### BACKGROUND OF THE INVENTION

### Field of the Invention

The invention relates to a lithium-ion battery that has at least one storage cell.

### Description of the Background Art

Lithium-ion batteries are widespread as storage devices for electrical energy. Among other fields, they are also used in the automotive field, where they serve, in particular, as so-called propulsion or traction batteries for driving hybrid or electric vehicles.

A lithium-ion battery has, as essential components, a positive electrode, a negative electrode, and an electrolyte. A multitude of examples are known in this context with regard to the precise construction. However, it is common to all examples that free, and thus mobile, lithium ions are present in the lithium-ion battery, which is to say lithium ions that can travel freely back and forth through the electrolyte between the negative electrode and the positive electrode.

A possible method for manufacturing lithium-ion batteries is outlined in Heimes, Heiner Hans; Kampker, Achim; Lienemann, Christoph; Locke, Marc; Offermanns, Christian; Michaelis, Sarah; Rahimzei, Ehsan, “Produktionsprozess einer Lithium-lonen-Batteriezelle” [Production process for a lithium-ion battery cell], Frankfurt am Main, PEM der RWTH Aachen und VDMA Eigendruck (2018), for example.

### SUMMARY OF THE INVENTION

It is therefore an object of the invention to provide an advantageously designed lithium-ion battery.

The lithium-ion battery according to the invention, also called secondary battery, storage battery, rechargeable battery, has at least one storage cell. Examples in which the battery has multiple storage cells are typical, however. In this case the storage cells customarily are then designed identically.

In addition, the at least one storage cell has at least one electrode sheet. That electrode sheet forms an electrode, which is to say a positive electrode or a negative electrode, in this case. The positive electrode acts as an anode during charging of the battery. Therefore, an electrode sheet that forms a positive electrode is hereinafter referred to as an anode sheet. The negative electrode, in turn, acts as a cathode during discharging of the battery. Therefore, an electrode sheet that forms a positive electrode is hereinafter referred to as a cathode sheet.

In addition, the at least one electrode sheet is extended in a longitudinal direction and, in particular, elongated. Consequently, the at least one electrode sheet has a length L. Moreover, the at least one electrode sheet is typically extended in a transverse direction as well as in a stacking direction. Consequently, the at least one electrode sheet then also has a width B as well as a thickness D. In this case, the height or thickness D is typically smaller than the width B and also smaller than the length L. Typically, D in this case is less than 0.01 L. Normally, it is also true that D is less than 0.01 B.

Moreover, the at least one electrode sheet is preferably formed by a coated film. Electrode sheets formed by coated films are known in principle in this context, and their manufacture is outlined in Heimes, Heiner Hans; Kampker, Achim; Lienemann, Christoph; Locke, Marc; Offermanns, Christian; Michaelis, Sarah; Rahimzei, Ehsan, “Produktionsprozess einer Lithium-lonen-Batteriezelle” [Production process for a lithium-ion battery cell], Frankfurt am Main, PEM der RWTH Aachen und VDMA Eigendruck (2018), for example.

In addition, the at least one electrode sheet can have a current collector, namely an electrode current collector. The current collector in this case can be formed by a film, in particular a metal film. In this design, the electrode current collector forms two contact tags or tabs, namely a first contact tag and a second contact tag. The electrode current collector thus forms not just one contact tag, as is the case with electrode sheets according to the prior art, but instead two contact tags.

This example is based on the consideration that the internal resistance in lithium-ion batteries increases when the dimensions of the electrode sheets increase, which is to say in the case of electrode sheets that are becoming longer and longer, for example. The internal resistance can be reduced with the aid of the additional, second contact tag, however. In this way, high energy densities can be achieved with no need to accept relatively large reductions with respect to fast charge capability.

It is expedient, moreover, when the electrode current collector is extended in the longitudinal direction, when it has, viewed in the longitudinal direction, two mutually opposite ends, and when each of the two ends forms one of the two contact tags. In this way, a relatively large spatial separation is achieved between the two contact tags.

Furthermore, depending on the application, the at least one electrode sheet can be extended in the longitudinal direction over a length greater than or equal to 300 mm, preferably greater than or equal to 500 mm and, in particular, greater than or equal to 700 mm. In particular, depending on the application, the electrode current collector of the at least one electrode sheet is extended in the longitudinal direction over a length greater than or equal to 300 mm, preferably greater than or equal to 500 mm and, in particular, greater than or equal to 700 mm.

As already mentioned previously, the electrode current collector can be formed by a film, in particular a metal film. The film in this case normally has an outer boundary that is formed by a closed curve which, in particular, lies in a plane that is spanned by the longitudinal direction and the transverse direction. The area delimited by the closed curve is covered preferably at least 80%, further preferably at least 90%, and in particular at least 95% by the metal film in this case. This means that the metal film preferably is not perforated, has no slits, and otherwise has no openings.

The at least one electrode sheet can be formed by a coated film, which is to say, in particular, a film of the above-described type to which a coating is applied. The relevant coating in this case is applied to one side of the film or to two opposite sides of the film depending on the application, in particular is applied extensively. It expediently has a so-called active material, namely an anode active material when the at least one electrode sheet is designed as an anode sheet, or a cathode active material when the at least one electrode sheet is designed as a cathode sheet. Appropriate active materials are known in principle here.

Also expedient is an example of the battery in which the at least one storage cell has at least one basic element. In this case, the basic element has two electrode sheets, which is to say, in particular, two electrode sheets of the above-described type, wherein one of the electrode sheets forms an anode sheet and the other a cathode sheet. Furthermore, in this case the anode sheet forms two contact tags, namely two primary contact tags, and moreover the cathode sheet also forms two contact tags, namely two secondary contact tags.

Depending on the design version, the at least one basic element furthermore has a separator sheet or an electrolyte sheet as an additional sheet. It is also typically the case for each additional sheet that it is extended in the longitudinal direction and, in particular, is elongated. Consequently, it has a length L. Moreover, it is typically extended in the transverse direction as well as in the stacking direction. Consequently, it also has a width B as well as a thickness D. In this case, the height or thickness D is typically smaller than the width B and also smaller than the length L. Typically, D in this case is less than 0.01 L. Normally, it is also true that D is less than 0.01 B.

Regardless thereof, an appropriate separator sheet expediently is made of a separator material and forms a separator. Suitable separator materials are known per se in this context. An appropriate electrolyte sheet, in turn, preferably has a solid-state electrolyte. Depending on the application, one of the sulfides Li₂S—P₂S₅, Li₂S—SiS₂, or Li₂S—GeS₂, one of the oxides Li₇La₃Zr₂O₁₂ (LLZO) or Li₃ₓLa_{2/3-3x}TiO₃ (LLTO), or one of the Li-argyrodites Li₆PS_{5X} (where X=Cl, Br, or I), Li₇PS₆, or Li₇PSe₆ is used as a solid-state electrolyte, for example.

The additional sheet is then expediently arranged between the anode sheet and the cathode sheet of the at least one basic element.

In accordance with another design version, the at least one basic element has two separator sheets as additional sheets. In this case, these preferably form a pocket in which one of the two electrode sheets of the basic element is enclosed.

The storage cell can have an enclosure as well as at least two basic elements arranged in the enclosure, namely a first basic element and a second basic element. In this design, each of the two basic elements has two primary contact tags, namely a first primary contact tag and a second primary contact tag. Furthermore, the storage cell has two primary cell current collectors that are each passed through the enclosure, namely a first primary cell current collector and a second primary cell current collector. In this case, the first primary contact tags are then connected to the first primary cell current collector within the enclosure and the second primary contact tags are connected to the second primary cell current collector within the enclosure.

Alternatively or in addition to the two primary contact tags, the two basic elements arranged in the enclosure each have two secondary contact tags, namely a first secondary contact tag and a second secondary contact tag. In this case, the first secondary contact tags are then connected to the first secondary cell current collector within the enclosure and the second secondary contact tags are connected to the second secondary cell current collector within the enclosure.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a battery having multiple storage cells, in a side view,

FIG. 2 shows a cell stack from one of the storage cells in a side view,

FIG. 3 shows a basic unit of the cell stack in a side view,

FIG. 4 shows the basic unit of the cell stack in a top view,

FIG. 5 shows a cathode sheet of the basic unit in a top view,

FIG. 6 shows an anode sheet of the basic unit in a top view, and

FIG. 7 shows a separator sheet of the basic unit in a top view.

### DETAILED DESCRIPTION

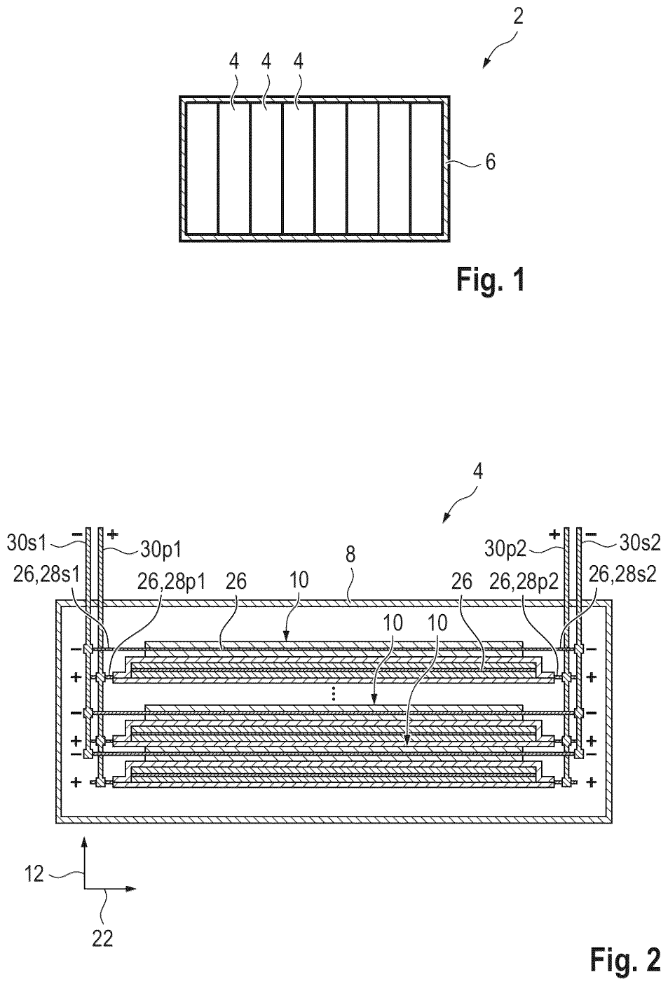

A lithium-ion battery 2 that is described below as an example is shown schematically in FIG. 1. It has multiple identically designed storage cells 4, which are arranged in a housing 6 of the lithium-ion battery 2.

One of these storage cells 4 is sketched in FIG. 2 in a sectional view. It is preferably designed as a so-called pouch cell and has an enclosure 8. Multiple identically designed basic elements 10 are stacked one on top of the other in a stacking direction 12 in the enclosure 8. Moreover, the enclosure 8 is filled with an electrolyte that is not shown in detail, for example LiPF₆.

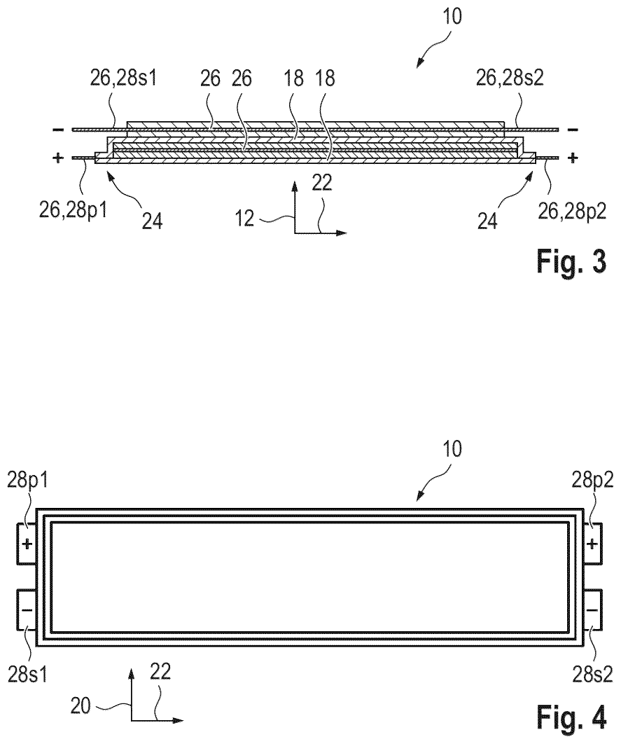

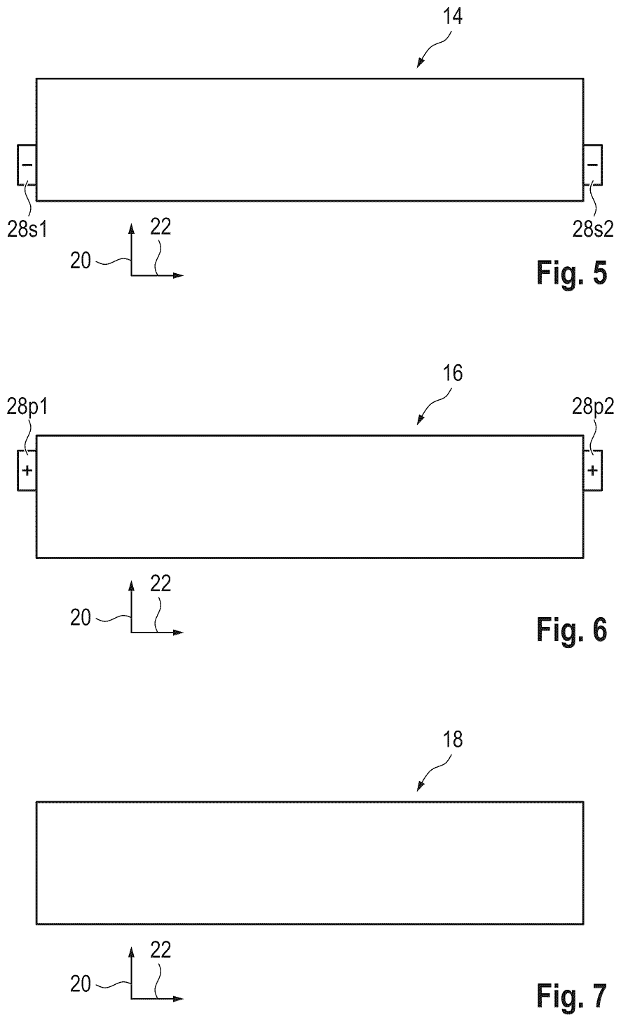

One of the basic elements 10 is shown in FIG. 3 in a sectional view and in FIG. 4 in a top view. It has four sheets, namely a cathode sheet 14 that is shown separately in FIG. 5, an anode sheet 16 that is shown separately in FIG. 6, and two separator sheets 18. It is true for each of the sheets that its thickness is considerably smaller than its width and its length. This means that its expanse in stacking direction 12 is smaller than its expanse in transverse direction 20 and also smaller than its expanse in longitudinal direction 22.

In addition, the separator sheets 18 are made of a separator material, which is to say, for example, a polyolefin. One of the separator sheets 18 is depicted as an example in FIG. 7.

The cathode sheet 14 and the anode sheet 16 are each formed by a coated metal film in the example. In this design, the cathode sheet 14 is formed, for example, by a coated copper film and the anode sheet 16 by a coated aluminum film. The coatings each have an active material. Thus, for example, graphite as cathode active material in the case of the cathode sheet 14 and, for example, LiCoO₂ as anode active material in the case of the anode sheet 16. In the example, moreover, the coatings are applied to the metal films on both sides, which is to say to two opposite sides of each metal film viewed in the stacking direction 12.

Furthermore, the two separator sheets 18 of a basic element 10 form a pocket in the example. To this end, the two separator sheets 18 are joined to one another along two edges 24. In the example, the two edges 24 each extend along the transverse direction 20 and delimit the pocket on two sides that are opposite in the longitudinal direction 22. The anode sheet 16 of the basic element 10 is additionally enclosed in the pocket. As a result, the two separator sheets 18 encircle the anode sheet 16 in the manner of a sleeve. This is evident from FIG. 3.

As already explained previously, the two electrode sheets 14, 16, which is to say the cathode sheet 14 and the anode sheet 16, are each formed by a coated metal film in the example. In both cases, the metal film forms an electrode current collector 26 in this design. In the example, the copper film thus forms the electrode current collector 26 of the cathode sheet 14 and the aluminum film forms the electrode current collector 26 of the anode sheet 16.

In addition, each electrode current collector 26 forms two contact tags 28, to be precise on two mutually opposite ends of the applicable electrode current collector 26 viewed in the longitudinal direction 22. In this design, the metal film of the anode sheet 16 forms a first primary contact tag 28p1 as well as a second primary contact tag 28p2, and the metal film of the cathode sheet 14 forms a first secondary contact tag 28s1 as well as a second secondary contact tag 28s2.

Each storage cell 4 additionally has four separate cell current collectors 30, namely a first primary cell current collector 30p1, a second primary cell current collector 30p2, a first secondary cell current collector 30s1, and a second secondary cell current collector 30s2. These four cell current collectors 30 are each passed through the enclosure 8. Thus, they extend through the enclosure 8 as a result. This is evident from FIG. 2.

Within the enclosure 8 of each storage cell 4, all first primary contact tags 28p1 of the storage cell 4 are connected to the first primary cell current collector 30p1, all second primary contact tags 28p2 of the storage cell 4 are connected to the second primary cell current collector 30p2, all first secondary contact tags 28s1 of the storage cell 4 are connected to the first secondary cell current collector 30s1, and all second secondary contact tags 28s1 of the storage cell 4 are connected to the second secondary cell current collector 30s2. In the example, the connections in this case are each formed by weld joints.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A lithium-ion battery comprising at least one storage cell that has at least one electrode sheet, the at least one electrode sheet is extended in a longitudinal direction, the at least one electrode sheet has an electrode current collector that forms a first contact tag and a second contact tag.

2. The lithium-ion battery according to claim 1, wherein the electrode current collector is extended in the longitudinal direction, wherein the electrode current collector has, viewed in the longitudinal direction, two mutually opposite ends, and wherein each of the two ends forms one of the two contact tags.

3. The lithium-ion battery according to claim 1, wherein the at least one electrode sheet is extended in the longitudinal direction over a length greater than or equal to 500 mm.

4. The lithium-ion battery according to claim 1, wherein the electrode current collector is formed by a film.

5. The lithium-ion battery according to claim 1, wherein the storage cell has at least one basic element, wherein the basic element has two electrode sheets, namely an anode sheet and a cathode sheet, wherein the anode sheet forms two contact tags, namely two primary contact tags, and wherein the cathode sheet forms two contact tags, namely two secondary contact tags.

6. The lithium-ion battery according to claim 5, wherein a separator sheet or an electrolyte sheet of the basic element is arranged between the anode sheet and the cathode sheet of the basic element.

7. The lithium-ion battery according to claim 5, wherein one of the two electrode sheets of the basic element is enclosed between two separator sheets of the basic element.

8. The lithium-ion battery according to claim 7, wherein the two separator sheets of the basic element form a pocket in which the one of the two electrode sheets is enclosed.

9. The lithium-ion battery according to claim 5, wherein the storage cell has an enclosure and two basic elements, namely a first basic element and a second basic element arranged in the enclosure, wherein each of the two basic elements has two primary contact tags, namely a first primary contact tag and a second primary contact tag, wherein the storage cell has two primary cell current collectors, namely a first primary cell current collector and a second primary cell current collector that are each passed through the enclosure, wherein the first primary contact tags are connected to the first primary cell current collector within the enclosure, and wherein the second primary contact tags are connected to the second primary cell current collector within the enclosure.

10. The lithium-ion battery according to claim 5, wherein the storage cell has an enclosure as well as two basic elements, namely a first basic element and a second basic element arranged in the enclosure, wherein each of the two basic elements has two secondary contact tags, namely a first secondary contact tag and a second secondary contact tag, wherein the storage cell has two secondary cell current collectors, namely a first secondary cell current collector and a second secondary cell current collector that are each passed through the enclosure, wherein the first secondary contact tags are connected to the first secondary cell current collector within the enclosure, and wherein the second secondary contact tags are connected to the second secondary cell current collector within the enclosure.
